(19) United States
(12) Patent Application Publication
(10) Pub. No.: US 2007/0148356 A1
(43) Pub. Date: Jun. 28, 2007

(54) Method to use an emulsified material as a coating

(75) Inventors: Christine R. Russell, Twinsburg, OH (US); David L. Westfall, Lakewod, OH (US); Deborah A. Langer, Chesterland, OH (US)

Correspondence Address: THE LUBRIZOL CORPORATION;ATTN: DOCKET CLERK, PATENT DEPT., 29400 LAKELAND BLVD., WICKLIFFE, OH, 44092, US

(73) Assignee: The Lubrizol Corporation, Wickliffe, OH (US)

(21) Appl. No.: 10/598,852

(22) PCT Filed: Mar. 14, 2005
(86) PCT No.: PCT/US05/08338

§ 371 Date: Oct. 18, 2006

Related U.S. Application Data
(60) Provisional application No. 60/553,762, filed on Mar. 17, 2004.

(51) Int. Cl. B05D 3/12; B05D 1/30; B05D 1/28; B05D 3/02; B05D 7/00

(52) U.S. Cl. 427/384; 427/421.1; 427/430.1; 427/429; 427/355; 427/420; 427/240

(57) ABSTRACT

The invention relates to a novel method to use an emulsified material as a surface coating comprising the steps of: (a) applying an emulsified material to a surface of a substrate and (b) drying or allowing to dry the emulsified material as a surface coating on the substrate. The method allows for the precision application of the emulsified material with increased viscosity onto a surface. Additionally, the emulsified material surface coating can easily be removed if desired.

### RELATED APPLICATION

This application claims priority from U.S. provisional application No. 60/553,762 “Method to Use an Emulsified Material As A Coating” filed Mar. 17, 2004.

### TECHNICAL FIELD OF INVENTION

The invention relates to a method to apply an emulsified material (aqueous discontinuous emulsion) onto a surface. The method further allows precision application of a viscous emulsion as a surface coating. Further the surface coating of the emulsified material imparts corrosion protection, oxidation protection, water protection, barrier protection and the like to the surface.

### BACKGROUND OF INVENTION

Surface coatings are useful to apply as a film or thin layer to a substrate to protect the surface of the substrate. Generally, coatings are efficient barriers to molecules from the environment. Coatings are needed to protect the substrate as a barrier to environmental elements, for corrosion protection, oxidation protection, water protection and the like.

The overall coating process in protecting vehicles typically involves applying many different layers of coatings from primers, to basecoats to topcoats and then a scratch resistant film or wax is applied. The scratch resistant film protects the vehicle body from surface chips, environmental pollutants and the like.

Additionally coatings come into contact with the environment through leakage, excretion during reapplication, general disposal, mechanical removal, water washout, thermal degradation and the like. The release or leakage of a coating may pose an environmental concern. The development of materials which contain a majority of water and natural products will lessen environmental contamination or impact which would result through the use of currently used coatings.

It is desirable for an emulsified material to be used as a coating to protect a substrate from oxidation, corrosion and other environmental materials. Further it is desirable for an emulsified material to be used as a surface coating that is environmentally friendly, less expensive, less toxic and less flammable.

There are many substrates in particular transported devices, equipment, wheels, vehicle, and the like that need their surface protected during transportation, or seasonably protected. Therefore, it is desirable that the emulsified material be applied easily as a removable surface coating to a substrate.

Emulsified materials as identified in U.S. Ser. No. 10/657671 entitled “Emulsified Materials” filed on Sep. 8, 2003 by the same assignee as herein discloses an effective emulsified material to be used as a coating composition. This patent application is incorporated by reference herein. Emulsified materials that have a high water content are generally more environmentally friendly and cost effective then those with a lower water content. However, as the water content increases the viscosity of the emulsified material increases and it is more difficult to apply a viscous emulsified surface coating in a uniform pattern.

An emulsified material has been discovered to be an effective surface coating. It has further been discovered that an emulsified coating can be delivered in a uniform fashion onto the surface of a substrate. It has further been discovered that the emulsified material is an improved surface coating providing a protective barrier to the substrate from environmental elements.

### SUMMARY OF THE INVENTION

The invention relates to a novel method to use an emulsified material as a surface coating comprising the steps of: (a) applying an aqueous discontinuous emulsified material to a surface of a substrate and (b) drying or allowing to dry the emulsified material as a surface coating on the substrate. The method allows for the precision application of the viscous emulsified material onto a surface. Additionally, the surface coating of the material can be removed, if desired.

The emulsified material comprises: (a) a major amount of an aqueous phase, (b) a minor amount of a non-aqueous phase and (c) a minor but effective amount of at least one emulsifier to emulsify the aqueous and non-aqueous phase resulting in an emulsified material.

More particularly the emulsified material comprises: (a) a major amount of water, (b) a non-aqueous component such an organic component, (c) at least one emulsifier, (d) optionally water soluble additives, (e) optionally alcohols and (f) optionally organic soluble additives, resulting in an emulsified material with a discontinuous aqueous phase in a continuous non-aqueous phase.

The emulsified material is made by a process comprising:

(a) mixing the following components
(1) a major amount of water,
(2) a minor amount of a non-aqueous component,
(3) at least one emulsifier,
(4) optionally water soluble additive(s),
(5) optionally an oil soluble additive(s),
(6) optionally an alcohol(s),
(7) optionally a hydrocarbon(s),
(8) optionally corrosion inhibitor(s),
(9) optionally a thickener(s),
(10) optionally a propellant(s), and
(11) combinations thereof;

(b) with sufficient shear to form a water in oil emulsion.

The emulsified material is a stable aqueous discontinuous emulsion, and in one embodiment preferably a water in oil emulsion, used as a surface coating on any type of substrate. The emulsified material and subsequent surface coating is environmentally friendly. In one embodiment the surface coating is generally biodegradable.

### DETAILED DESCRIPTION OF THE INVENTION

The present invention relates to a variety of substrate surfaces protected by an emulsified material and a method to apply the emulsified material as a coating to the surface of a substrate.

The emulsion formed has a non-aqueous continuous phase while the aqueous phase forms the discontinuous phase dispersed in the continuous phase. The major amount of the emulsified material is an aqueous phase. The aqueous phase includes water and the like. The water may be taken from any source. The water includes tap, deionized, demineralized, purified and the like. Combinations may be used.

The emulsified material has an aqueous phase content in the range of about 5% to about 99%, in one embodiment about greater than 50% to about 98%, in another embodiment about 60% to about 85%, in another embodiment about 60% to about 70%, and in another embodiment about 70% to about 80% by weight of the emulsified material. The emulsified material at the time of preparing the material has a viscosity in the range of about 200 cSt to about 5,000,000 cSt, in one embodiment in the range of about 10,000 cSt to about 2,000,000 cSt and in another embodiment in the range of about 100,000 cSt to about 1,000,000 cSt. The viscosity is measured on a Brookfield Viscometer with a No. 7 spindle at 2 rpm and 25° C. The emulsions can also be of a consistency which allows it to be evaluated on a penetrometer according to the ASTM D217 procedure.

The emulsified material having a major amount of the aqueous internal phase is more viscous than if the aqueous internal phase was less. The method allows for the viscous emulsified material with a major amount of an aqueous internal phase to be applied in a uniform pattern onto the surface of a substrate. The method allows for the precision delivery of the continuous non-aqueous phase onto the surface of the substrate. Generally, the aqueous phase or some or most of it may dissipate during the precision delivery method of the emulsified material. The aqueous discontinuous phase acts to give the precision delivery of a thin film of the coating. The level of the discontinuous aqueous phase allows for a highly viscous emulsified material to be sprayed on a surface and for further obtain a uniform spray pattern. The method allows for precision application of the emulsified material as a surface coating on a substrate.

The invention allows for a viscous emulsified material to be sprayed onto a substrate resulting in an even uniform coating of the viscous material. The volatile, immiscible aqueous phase then evaporates from the surface of the substrate resulting in a thin uniform surface coating on the substrate. In one embodiment the viscous organic material i.e. the grease with a corrosion inhibitor additive in it is applied in a uniform thin layer. The organic material is delivered onto the substrate by a spray application in a controlled fashion via invert emulsification.

The non-aqueous continuous phase also impacts the viscosity of the emulsified material due to the inherent properties of the non-aqueous component.

The non-aqueous phase includes but is not limited to organic materials, oils, greases, thickened oils, thickened greases, gels, thickened solvents, monomers, polymeric materials, solvents, waxes and the like. The non-aqueous phase components can be used alone or in combination. The emulsified material contains a non-aqueous component and is used in the range from about 1% to about 95%, in one embodiment from about 5% to about 49% and in another embodiment from about 40% to about 20% by weight of the emulsified materials.

The emulsified material has a mean particle droplet size in the range of 0.005 micron to about 20 micron, in another embodiment in the range of about 0.1 micron to about 10 micron, and in another embodiment of the range of about 0.5 micron to about 5 micron.

The method to apply the emulsified material as a surface coating comprises applying the emulsified material on a surface and then drying or allowing to dry the emulsified material on the surface resulting in a protected surface. The emulsified material as a surface coating acts as a barrier, a strengthener for the surface and/or protects the substrate from corrosion, evaporation, oxidation, water, adhesion, dissociation, degradation, wear and the like. The surface coating can protect the substrate from a combination of these.

The surface coating includes translucent, opaque, transparent and the like. The surface coating includes temporary, permanent, semi-permanent, removable and the like coating. The emulsified material is applied to a surface of the substrate wherein the surface includes smooth, rough, semi-rough, planar, irregular, porous, non-porous, semi-porous and the like.

The substrate for the surface coating includes metal, wood, concrete, stone, asphalt, glass, plastic, composites, fabric, rubber, carbon steel, stainless steel, aluminum and the like. The surface material may be a combination of materials. The emulsified material provides protection on substrates such as pieces, parts and components, walls, automobiles, trucks, railcars, heavy industrial equipment, boats, stationary structures, agriculture equipment, agricultural material, architectural structures, bridges, overpasses and the like on surfaces. The surface coating may be used for painted surfaces such as automobiles, trucks, boats and the like. Further, the emulsified material is also useful in metalworking applications that need lubrication and/or corrosion and/or oxidation protection during metal fabrication of aluminum, ferrous and metal products such as rolling, drawing, stamping, and forging of ball bearings, cutting, grinding, drilling and milling, and the like. Further the emulsified material is also useful as a surface coating for seasonal substrates or substrates that need temporary surface coating or the like. Further the emulsified material may be used in agricultural uses such as coating agricultural material.

The surface coating may be applied by a variety of techniques to the surface and generally it is done at ambient temperature or higher, if desired. The coating method includes spraying, dipping, spinning, vacuum deposition techniques, reverse rolling, wire-wound or Mayer rod, direct and offset gravure, slot dieing, blading, hot melting, curtain, knife over rolling, extruding, air knife, rotary screening, multilayer sliding, painting, brushing, co extrusion, meniscus, micro gravure coaters, atomizers such as plain jet, flat, cone, hollow or solid, air atomizing, airless or air-assisted airless air atomizing; supercritical fluid, electrostatic and rotary, either an internal-or-external-mix atomizer design, and mixtures thereof and the like. The method to apply can be singular or combination of methods. The choice of the method depends on the nature of the substrate to be coated, the rheology and composition of the emulsified material, the wet-coating weight or coverage desired, the coating uniformity desired, coating width and speed desired, the number of layers to be coated simultaneously, cost and environmental considerations, whether the coating is to be continuous or intermittent and the like. Further, the method to coat a given surface depends on the characteristics of the material to be sprayed, the work piece configuration, the surface characteristics desired, the application rate required and the like.

In one embodiment application of the surface coating by a spraying method is preferred. In another embodiment the preferred method of application is painting, rolling, brushing, and the like and combinations thereof.

In one spray embodiment, an aluminum one-piece can with about 70% product fill, about 20% propellant(s) and about 10% hydrocarbon(s) utilizes a normal and inverted actuator about 0.030″ tip (aerosol “button”), a flow about 80 g/s. This aerosol container is one application of airless atomization. In another embodiment fluid delivery in an air-spray system may be pressure or suction fed. In another embodiment, a pressure-feed system with air-assisted airless internal mixing atomization is preferred. In another embodiment, compressed air operating at about 35 to about 1050 kPa with a range of about 5 to about 150 psi is introduced adjacent to the airless nozzle and impinges upon the thin sheet of fluid as it exits from the spray nozzle orifice described as about 0.005″ to about 0.020″ tip, in another embodiment about 70 psi air and about 0.013″ tip. The air aggravates the fluid turbulence and results in atomization at fluid pressures in the range of about 25 to about 929 kPa with a range of about 170 to about 6500 psi providing a thin uniform film, less than about 0.001″ wet coating, with minimal overspray or misting and excellent penetration into recessed areas.

After the application of the surface coating the coating is then solidified or dried or allowed to solidify or dry. Drying involves the removal of the volatile components thereof Drying occurs by the allowance of the water, solvent and/or the like dissipating at application and/or evaporating from the surface. Drying also includes curing or polymerizing of monomeric components. Drying can occur through these methods alone or in combination. Drying occurs in the range of subambient to ambient to elevated temperatures; in one embodiment the drying temperature is in the range of about −20° C. to about 300° C., in another embodiment it is in the range of about 0° C. to about 110° C., and in another embodiment it is in the range of about 0° C. to about 50° C.

The thickness of the dried surface coating however will differ depending on the characteristics of the surface of the substrate being coated. Generally the surface coating thickness is in the range of about 0.001 micron to about 50 micron, in another embodiment in the range of about 0.01 micron to about 10 micron and in another embodiment in the range of about 0.05 micron to about 5 micron. In one embodiment it is preferred that the surface coating is applied as a thin film. In another embodiment it is preferred that the surface coating is a viscous organic material that is a grease with a corrosion inhibitor additives in it and has the viscous material in the aqueous phase of equal to or less than about 70% and the volatile, immiscible aqueous phase then evaporates from the surface of the substrate resulting in a thin uniform surface coating on the substrate.

In one embodiment for some applications the surface coating is completely and/or partially removed. The surface coating is removed by methods which include water wash, detergent wash, solvent wash and the like. Combinations of removal methods may be used.

Conventional thickeners can be used in the emulsified materials that are either water soluble, oil soluble, or combinations thereof. Thickeners for the emulsified material are generally known in the art.

The non-aqueous phase thickeners include alkali and alkaline earth metal soaps of fatty acids and fatty materials, the metals are typified by sodium, lithium, calcium, magnesium, aluminum and barium, and examples of fatty materials include stearic acid, hydroxystearic acid, oleic acid, palmitic acid, myristic acid, cottonseed oil acids, hydrogenated fish oils, urea-derived polymers, salt and salt-soap complexes, such as calcium stearate-acetate, barium stearate-acetate, calcium stearate-caprylate-acetate complexes, calcium salts and soaps of low, intermediate and high molecular weight acids and of nut oil acids, aluminum stearate, aluminum complex thickeners and lithium 12-hydroxy stearate, clays, tetraalkyl ammonium chlorides, silicates, bentonite, attapulgite, hectorite, illite, saponite, sepiolite, biotite, vermiculite, zeolite clays and the like. Combinations of the thickeners may be used.

Viscosity modifiers can also be used as thickeners for these systems. These thickeners include polyacrylates; polymethacrylates; olefin co-polymers; functionalized olefin copolymers, such as reaction products with maleic anhydride; ethylene/propylene/diene terpolymers; functionalized ethylene/propylene/diene terpolymers, such as reaction products with maleic anhydride; the esterified reaction products of maleic anhydride/styrene co-polymers; styrene-butadiene copolymers and similar compositions apparent to those skilled in the art.

The non-aqueous phase thickener is employed in the amount from about 0% to about 20%, preferably from about 0.05% to about 10% and more preferably about 0.1% to about 5% of the emulsion material.

The aqueous phase includes water soluble additives that include alcohols; water soluble extreme pressure (EP) antiwear additives; water-soluble organic compounds; water-soluble inorganic compounds; polymeric initiators; acids; bases; water-soluble monomers; functionalized polymers; antimicrobials; biocides; water soluble additives; water soluble dithiophosphate salts; water soluble dithiophosphate esters; water soluble corrosion inhibitors and combinations thereof.

The water soluble additives are present in the range of about 0% to about 50%, preferably about 0.1% to about 30% and more preferably about 1% to about 20% by weight of the emulsified material.

The aqueous phase thickeners include surfactant gels which are two or more surfactants that associate with each other to form a gel such as the combination of lauryl sulfobetaine and cationic surfactants. The aqueous phase thickeners further include water-soluble polymeric thickeners, such as polysaccharides, synthetic thickening polymers, or mixtures these examples include gums, gum agar, guar gum, gum arabic, algin, dextrans, xanthan gum, cellulose ethers and esters, hydroxethyl cellulose, sodium salt of carboxymethyl cellulose, clays and the like, and combinations thereof.

The thickener is employed in an amount from about 0% to about 10%, preferably from 0. 1% to about 7% and more preferably about 0.3% to about 5% by weight of the emulsified material.

The emulsified material may contain non-aqueous soluble additives in the continuous phase. The non-aqueous soluble additives include extreme pressure (EP) anti-wear additives, metal deactivators, dispersants, antifoams, corrosion inhibitors, rust inhibitors, antioxidants, detergents, polymers and functionalized polymers and other useful additives for providing enhanced performance characteristics of the emulsified material and are known in the art. The amount of the non-aqueous soluble additive depends on the specific performance characteristics designed for the emulsified material and is generally in the range of about 0% to about 75%, preferably from about 0.5% to about 60% and more preferably from about 1% to about 20% of the emulsified material.

Extreme pressure anti-wear additives that are in the non-aqueous phase include a sulfiu or chlorosulphur EP agent, a chlorinated hydrocarbon EP agent, or a phosphorus EP agent, or mixtures thereof. The non-aqueous soluble EP agents are in the range of about 0% to about 12%, preferably from about 0.5% to about 10% and more preferably from about 1% to about 6% by weight of the emulsified material.

Solid additives in a particle or finely divided form may also be used at levels of 0% to 20% of the emulsified material. These include graphite, molybdenum disulfide, zinc oxide, titanium dioxide, boron nitride, polytetrafluoroethylene, metallic zinc or other metals in their ground valence state and the like. Mixtures of solid additives may be used.

Non-aqueous soluble monomers include but are not limited to acrylates, acrylamides, acrylate esters, methacrylate esters, alpha-alkyl acrylic acids, styrenes, vinyl aromatic monomers, acrylonitriles, vinyl-substituted nitrogen heterocyclic monomers, alpha-alkyl substituted acrylate esters, alpha-alkyl substituted acrylamides, vinyl acetate and other esters of vinyl alcohol.

Aqueous soluble monomers include but are not limited to water-soluble acryloamide, water-soluble acrylamido sulfonates, acrylo sulfonic acids, acrylo sulfonates, acrylic acids, methacrylic acids, acrylamide, N-methyl acrylamide, N,N-dimethylacrylamide, N-vinylpyrrolidone, 2-hydroxyethyl methacrylate, 2-hydroxypropyl methacrylate.

Non-aqueous soluble polymers and functionalized polymers include polyisobutenes, polymethacrylate acid esters, polyacrylate acid esters, diene polymers, polyalkyl styrenes, alkenyl aryl conjugated diene copolymers, polyolefins and multifunctional viscosity improvers, including dispersant viscosity modifiers. Combinations may be used. The non-aqueous soluble polymers including functionalized polymers are present in the range of about 0% to about 50%, preferably, about 0.01% to about 25%, and more preferably about 0.02% to about 18% by weight of emulsified material.

The antioxidants that are used in the non-aqueous phase include phenate sulfides, phosphosulfuirized terpenes, sulfuiized esters, aromatic amines, and hindered phenols, and the like. Combinations may be used. The antioxidants are in the range of about 0% to about 10%, preferably about 0.25% to 6%, and more preferably about 0.5% to about 3% by weight of the emulsified material.

Metal deactivators include benzotriazole, benzimidazole, 2-alkyldithio-benzimidazoles, 2-alkyldithiobenzothiazoles, 2-(N,N-dialkyldithiocarbamoyl)-benzothiazoles, 2,5-bis(alkyl-dithio)-1,3,4-thiadiazoles, and 2,5-bis(N,N-dialkyl-dithiocarbamoyl)-1,3,4-thiadiazoles. Combinations maybe used. The metal deactivators are in the range of 0% to about 5% preferably about 0.1% to about 4% and more preferably about 0.2% to about 3% by weight of the emulsified material.

Antifoams include organic silicones such as dimethyl silicone and the like. Combinations may be used. The antifoams are in the range of about 0% to about 2%, preferably about 0.01% to about 1%, and more preferably 0.02% to about 0.7% by weight of the emulsified material.

Anticorrosion compounds include alkyl substituted aliphatic dicarboxylic acids such as alkenyl and succinic acids, ash-containing detergents, sodium nitrite, oxidized wax, calcium salts of oxidized paraffin wax, magnesium salts of oxidized paraffm wax, alkali metal salts, alkaline earth metal salts or amine salts of beef tallow fatty acids, alkenyl succinates or alkenyl succinic acid half esters (whose alkenyl moiety has a molecular weight of about 100 to 500), glycerol monoesters, nonylphenyl ethoxylate, lanolin fatty acid esters, and calcium salts of lanolin fatty acids. Combinations may be used. The anticorrosion compounds are in the range of about 0% to about 10%, preferably about 0.1% to about 8%, and more preferably 0.2% to about 6% by weight of the emulsified material.

In one preferred embodiment, the anticorrosion agent is an ash-containing detergents, which are described as basic alkali or alkaline earth metal salt of a sulfonic or carboxylic acid. In one embodiment, it is desirable to include at least one alkali metal or alkaline earth metal salt of a sulfonic or carboxylic acid, or mixtures thereof, in the emulsified material. Of the alkali metals, sodium and potassium are preferred, and of the alkaline earth metals, calcium, magnesium, barium and strontium are preferred. Salts containing a mixture of ions of two or more of the alkali and alkaline earth metals can be used. The basic metal salts will have metal ratios of from about 2 to about 30 or 40.

The sulfonic acids are generally petroleum sulfonic acids or synthetically prepared alkaryl sulfonic acids.

Suitable carboxylic acids from which useful alkali and alkaline earth metal salts can be prepared include aliphatic, cycloaliphatic and aromatic mono- and polybasic carboxylic acids free from acetylenic unsaturation. The aliphatic acids generally contain from about 8 to about 50, and preferably from about 12 to about 25 carbon atoms. The cycloaliphatic and aliphatic carboxylic acids are preferred, and they can be saturated or unsaturated. Specific examples include 2-ethylhexanoic acid, linolenic acid, propylene tetramer-substituted maleic acid, behenic acid, isostearic acid, pelargonic acid, capric acid, palmitoleic acid, linoleic acid, lauric acid, oleic acid, ricinoleic acid, undecyclic acid, dioctylcyclopentanecarboxylic acid, myristic acid, dilauryldecahydronaphthalene-carboxylic acid, stearyloctahydroindenecarboxylic acid, palmitic acid, alkyl-and alkenylsuccinic acids, acids formed by oxidation of petrolatum or of hydrocarbon waxes, and commercially available mixtures of two or more carboxylic acids such as tall oil acids, rosin acids, and the like.

Emulsifiers

The emulsified material contains at least one emulsifier. The emulsifier must be capable of producing an aqueous discontinuous phase in a non-aqueous continuous phase emulsion to form the emulsified material that is applied as a surface coating. Low hydrophiliclipophilic (sometimes called lyophilic) balance (HLB) surfactants are employed within a range of less than or equal to HLB 9.0, (1 to 40) preferably HLB of 0 to 7, and more preferably with an HLB in the range of 4 to 6. Surfactants with HLBs higher than 9 can be used provided they are combined with lower HLB surfactants to give a composite emulsifier system with an HLB in the range that produces water in oil emulsions. The procedures to do this are generally known in the art such as blending the two emulsifiers/surfactants together using typical blending equipment.

The emulsifier is present in the range of about 0.1 to about 20%, more preferably 0.1 to about 10%, or more preferably about 0.3 to about 7.0% of the emulsified material.

The Emulsifier Includes

(i) a oil soluble product made by reacting at least one hydrocarbyl-substituted carboxylic acid acylating agent with ammonia or an amine including but not limited to alkanol amine, hydroxy amine, and the like, the hydrocarbyl substituent of said acylating agent having about 50 to about 500 carbon atoms;

(ii) any other acylating agent having at least one hydrocarbyl substituent of up to about 40 carbon atoms, and reacting that said acylating agent with ammonia or an amine;

(iii) any other ionic or a nonionic compound having a hydrophilic-lipophilic balance (HLB) of about 1 to about 40

(iv) the reaction product of a polyacidic polymer with at least one oil soluble product made by reacting at least one hydrocarbyl-substituted carboxylic acid acylating agent with ammonia, an amine, a polyamine, an alkanol amine or hydroxy amines;

(v) an amino alkylphenol which is made by reacting an alkylphenol, an aldehyde and an amine resulting in an amino alkylphenol;

(vi) a hydrocarbyl substituted carboxylic acid, or a reaction product of the hydrocarbyl substituted carboxylic acid or a reactive equivalent of such acid with an alcohol or water, the hydrocarbyl substituent of the acid or reactive equivalent thereof containing at least about 30 carbon atoms;

(vii) at least one compound represented by one or more of the formulae: 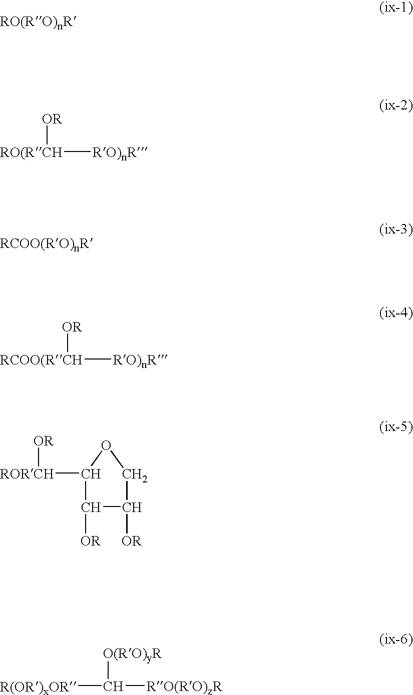
wherein each R is independently hydrogen or a hydrocarbyl group of up to about 60 carbon atoms; each R′ and R″ is independently an alkylene group of 1 to about 20 carbon atoms; each R′″ is independently hydrogen, or an acyl or hydrocarbyl group of up to about 30 carbon atoms; n is a number in the range of zero to about 50; and x, y and z are independently numbers in the range of zero to about 50 with the total for x, y and z being at least 1;

(viii) an etheramine represented by the formula
R²O[CH₂CH(R)O]ₙ—R¹—NH₂
wherein each n is a number from 0 to 50; each R is selected from the group consisting of hydrogen, hydrocarbyl groups of 1 to 16 carbon atoms, and mixtures thereof; each R.sup.1 is selected from the group consisting of a hydrocarbylene group containing 2 to 18 carbon atoms and a group represented by the formula
—R⁶Nₚ—R⁷—
wherein both R⁶ and R⁷ are hydrocarbylene groups of 3 to 10 carbon atoms and p is a number from 1 to 4; and each R² is a hydrocarbyl group having a valence of y where y is a number from 1 to 3, and containing 1 to 50 carbon atoms when y is 1 and 1 to 18 carbon atoms when y is 2 or 3; provided that when n is zero, y is 1;

(ix) a phospholipid, any lipid containing a phosphoric acid or ester group, such as lecithin or cephalin;

(x) An amine represented by the formula:
R—NH₂
where R=a poly(isobutenyl) group of molecular weight between 350 and 3000; or

(xi) the combination of any other above listed emulsifiers.

The emulsifier is present in the emulsified material at a concentration of about 0.001% to about 20% by weight, in another embodiment about 0.05% to about 10% by weight, in another embodiment about 0.1% to about 5% by weight, and in a fuither embodiment of about 0.2% to about 4% by weight of the emulsified material. Combinations of emulsifiers may be used.

The non-aqueous product (i) of the emulsifier may be at least one oil-soluble product made by reacting at least one hydrocarbyl-substituted carboxylic acid acylating agent with ammonia or an amine including but not limited to alkanol amines, hydroxy amines, and the like, the hydrocarbyl substituent of said acylating agent having about 50 to about 500 carbon atoms, and is described in greater detail in U.S. Ser. No. 09/761,482, An Emulsifier For An Aqueous Hydrocarbon Fuel, incorporated by reference herein.

The hydrocarbyl-substituted carboxylic acid acylating agents may be carboxylic acids or reactive equivalents of such acids. The reactive equivalents may be acid halides, anhydrides, or esters, including partial esters and the like. The hydrocarbyl substituents for these carboxylic acid acylating agents may contain from about 50 to about 500 carbon atoms, and in one embodiment about 50 to about 300 carbon atoms, and in one embodiment about 60 to about 200 carbon atoms. In one embodiment, the hydrocarbyl substituents of these acylating agents have number average molecular weights of about 700 to about 3000, and in one embodiment about 900 to about 2300.

The hydrocarbyl substituted acylating agents have a hydrocarbyl group substituent that is derived from a polyolefin, with polydispersity and other features as described below. Generally, it has a number average molecular weight of at least 600, 700, or 800, to 5000 or more, often up to 3000, 2500, 1600, 1300, or 1200. The polyolefin polymer may be a polyisobutene, polypropylene, polyethylene, a copolymer derived from isobutene and butadiene, or a copolymer derived from isobutene and isoprene. The hydrocarbyl group is typically derived from a polyolefin or a polymerizable derivative thereof, including homopolymers and interpolymers of olefin monomers having 2 to 30, to 6, or to 4 carbon atoms, and mixtures thereof. The polyolefin may have a M̅_{w}/ M̅ₙ greater than about 5. In a preferred embodiment the polyolefin is polyisobutene.

The hydrocarbyl-substituted carboxylic acid acylating agents may be made by reacting one or more alpha-beta olefinically unsaturated carboxylic acid reagents containing 2 to about 20 carbon atoms, exclusive of the carboxyl groups, with one or more olefin polymers.

In one embodiment, the hydrocarbyl-substituted carboxylic acid acylating agent is a polyisobutene-substituted succinic anhydride, the polyisobutene substituent having a number average molecular weight of about 1,500 to about 3,000, and in one embodiment about 1,800 to about 2,300, said first polyisobutene-substituted succinic anhydride being characterized by about 1.3 to about 2.5, and in one embodiment about 1.7 to about 2.1, in one embodiment about 1.0 to about 1.3, and in one embodiment about 1.0 to about 1.2 succinic groups per equivalent weight of the polyisobutene substituent.

The oil soluble product (i) may be formed using ammonia, an amine and/or the metal bases of metals such as Na, K, Ca, and the like. The amines useful for reacting with the acylating agent to form the product (i) including but are not limited to, monoamines, polyamines, alkanol amines, hydroxy amines, and mixtures thereof, and amines may be primary, secondary or tertiary amines.

The oil-soluble product (i) may be a salt, an ester, an ester/salt, an amide, an amide, or a combination of two or more thereof.

The second acylating agent (ii) of this invention includes carboxylic acids and their reactive equivalents such as acid halides and anhydrides.

In one embodiment, the carboxylic acid is a monocarboxylic acid of about 1 to about 35 carbon atoms, and in one embodiment about 16 to about 24 carbon atoms. Examples of these monocarboxylic acids include lauric acid, oleic acid, isostearic acid, palmitic acid, stearic acid, linoleic acid, arachidic acid, gadoleic acid, behenic acid, erucic acid, tall oil fatty acids, lignoceric acid and the like. These acids may be saturated, unsaturated, or have other functional groups, such as hydroxy groups, as in 12-hydroxy stearic acid, on the hydrocarbyl backbone.

In one embodiment, the carboxylic acid is a hydrocarbyl-substituted succinic acid represented correspondingly by the formula 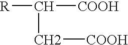
wherein formula R is hydrocarbyl group of about 12 to about 40. The production of such hydrocarbyl-substituted succinic acids or anhydrides via alkylation of maleic acid or anhydride or its derivatives with a halohydrocarbon or via reaction of maleic acid or anhydride with an olefin polymer having a terminal double bond is known to those of skill in the art.

The ionic or nonionic compound (iii) of the emulsifier has a hydrophilic-lipophilic balance (HLB, which refers to the size and strength of the polar (hydrophilic) and non-polar (lipophilic) groups on the surfactant molecule) in the range of about 1 to about 40, and in one embodiment about 4 to about 15 and is described in greater detail in U.S. Ser. No. 09/761,482, An Emulsifier For An Aqueous Hydrocarbon Fuel, incorporated by reference herein. Examples of these compounds are disclosed in McCutcheon's Emulsifiers and Detergents, 1998, North American & International Edition. Pages 1-235 of the North American Edition and pages 1-199 of the International Edition are incorporated herein by reference for their disclosure of such ionic and nonionic compounds having an HLB in the range of about 1 to about 40, in one embodiment about 1 to about 30, in one embodiment about 1 to 20, and in another embodiment about 1 to about 10. Examples include low molecular weight variants of (i) or (vii) such as those having a hydrocarbon group in the range of C₈ or C₂₀. Useful compounds include alkanolamines, carboxylates including amine salts, metallic salts and the like, alkylarylsulfonates, amine oxides, poly(oxyalkylene) compounds, including block copolymers comprising alkylene oxide repeat units, carboxylated alcohol ethoxylates, ethoxylated alcohols, ethoxylated alkylphenols, ethoxylated amines and amides, ethoxylated fatty acids, ethoxylated fatty esters and oils, fatty esters, fatty acid amides, including but not limited to amides from tall oil fatty acids and polyamides, glycerol esters, glycol esters, sorbitan esters, imidazoline derivatives, lecithin and derivatives, lignin and derivatives, monoglycerides and derivatives, olefin sulfonates, phosphate esters and derivatives, propoxylated and ethoxylated fatty acids or alcohols or alkylphenols, sorbitan derivatives, sucrose esters and derivatives, sulfates or alcohols or ethoxylated alcohols or fatty esters, sulfonates of dodecyl and tridecyl benzenes or condensed naphthalenes or petroleum, sulfosuccinates and derivatives, and tridecyl and dodecyl benzene sulfonic acids.

In one embodiment the emulsifier (iv) is the reaction product of A) a polyacidic polymer, B) at least one oil soluble product made by reacting at least one hydrocarbyl-substituted carboxylic acid acylating agent, and C) a hydroxy amine and/or a polyamine and is described in greater detail in U.S. Ser. No. 09/761,482, An Emulsifier For An Aqueous Hydrocarbon Fuel, incorporated by reference herein.

The amino alkyl emulsifier (v) is comprised of the reaction product of an amino alkylphenol, an aldehyde, and an amine resulting in amino alkylphenol. The amino alkylphenol can be made by (a) the reaction of alkylphenol directly with an aldehyde and an amine resulting in an alkylphenol monomer connected by a methylene group to an amine, (b) the reaction of an alkylphenol with an aldehyde resulting in an oligomer wherein the alkylphenols are bridged with methylene groups, the oligomer is then reacted with more aldehyde and an amine to give a Mannich product, or (c) a mixture of (a) and (b) and is described in greater detail in U.S. Ser. No. 09/977,747 entitled A Continuous Process For Making An Aqueous Hydrocarbon Fuel Emulsion incorporated by reference herein.

The emulsifier component (vi) may be a hydrocarbyl substituted carboxylic acid, or a reaction product of the hydrocarbyl substituted carboxylic acid or a reactive equivalent thereof with an alcohol or water. The carboxylic acids may be monobasic or polybasic. The polybasic acids include dicarboxylic acids, although tricarboxylic and tetracarboxylic acids may be used. The reactive equivalents may be acid halides, (e.g., chlorides), anhydrides or esters, including partial esters, and the like.

The emulsifier component (vi) may be in the form of an acid, an ester, or a mixture thereof. The acid may be formed by reacting a hydrocarbyl substituted carboxylic acid reactive equivalent with water to provide the desired acid. For example, hydrocarbyl (e.g., polyisobutene) substituted succinic anhydride may be reacted with water to form hydrocarbyl substituted succinic acid, or with an alcohol to form and ester. The reaction between the hydrocarbyl substituted carboxylic acid or reactive equivalent thereof and the alcohol to form an ester may be carried out under suitable ester forming reaction conditions. In one embodiment, the hydrocarbyl substituted carboxylic acid or reactive equivalent thereof and the alcohol are reacted in amounts sufficient to provide from about 0.3 to about 3 equivalents of the acid or reactive equivalent thereof per equivalent of alcohol. In one embodiment, this ratio is from about 0.5:1 to about 2:1.

The emulsifier component (vii) may be at least one compound represented by one or more of the formulae: 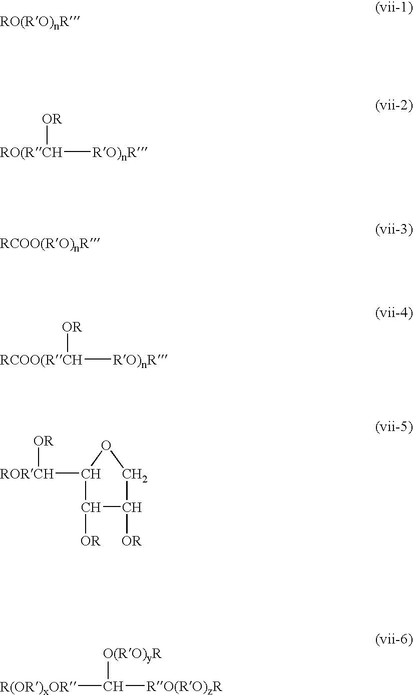
wherein each R is independently hydrogen or a hydrocarbyl group of up to about 60 carbon atoms; each R′ and R″ is independently an alkylene group of 1 to about 20 carbon atoms; each R′″ is independently hydrogen, or an acyl or hydrocarbyl group of up to about 30 carbon atoms; n is a number in the range of zero to about 50; and x, y and z are independently numbers in the range of zero to about 50 with the total for x, y and z being at least 1. In the above formulae, R may be a hydrocarbyl group of about 6 to about 60 carbon atoms, and in one embodiment abut 6 to about 45 carbon atoms, and in one embodiment about 6 to about 30 carbon atoms. R′ and R″ may be independently alkylene groups of about 1 to about 6 carbon atoms, and in one embodiment about 1 to about 4 carbon atoms. In one embodiment, R′″ may be an acyl or hydrocarbyl group of 1 to about 30 carbon atoms, and in one embodiment 1 to about 24 carbon atoms, and in one embodiment 1 to about 18 carbon atoms, and in one embodiment 1 to about 12 carbon atoms. n may be a number in the range of 1 to about 50, and in one embodiment 1 to about 30, and in one embodiment 1 to about 20, and in one embodiment 1 to about 12. x, y and z may be independently numbers in the range of zero to about 50, and in one embodiment zero to about 30, and in one embodiment zero to about 10; with the total of x, y and z being at least 1, and in one embodiment in the range of 1 to about 50.

Examples of compounds represented by formula (vii-1) that may be used include: C₉-C₁₁ alkoxy poly (ethoxy)₈ alcohol; C₁₂-C₁₅ alkoxy poly (isopropoxy)₂₂-26 alcohol; oleyl alcohol pentaethoxylate; and the like.

Examples of compounds represented by formula (vii-2) that may be used include diglycerol monooleate, diglycerol monosteaate, polyglycerol monooleate, and the like.

Examples of compounds represented by formula (vii-3) that may be used include polyethylene glycol (Mn=200) distearate, polyethylene glycol (Mn=400) distearate, polyethylene glycol (Mn=200) dioleate, polyethylene glycol (Mn=400) soya bean oil ester, and the like.

Examples of compounds represented by formula (vii-4) that may be used include glycerol monooleate, diglycerol dioleate, diglycerol distearate, polyglycerol dioleate, and the like.

Examples of compounds represented by formula (vii-5) that may be used include sorbitan monooleate, sorbitan monoisostearate, sorbitan sesquioleate, and sorbitan trioleate, and the like.

Examples of compounds represented by formula (vii-6) that may be used include polyethoxy glycerol trioleate wherein the compound contains 25 ethoxy groups.

The emulsifier (viii) can be an etheramine represented by the formula
R²O[CH₂CH(R)Oₙ—R¹—NH₂ (viii-a)
wherein each n is a number from 0 to 50; each R is selected from the group consisting of hydrogen, hydrocarbyl groups of 1 to 16 carbon atoms, and mixtures thereof; each R¹ is selected from the group consisting of a hydrocarbylene group containing 2 to 18 carbon atoms and a group represented by the formula
—R⁶Nₚ—R⁷—
wherein both R⁶ and R⁷ are hydrocarbylene groups of 3 to 10 carbon atoms and p is a number from 1 to 4; and each R² is a hydrocarbyl group having a valence of y where y is a number from 1 to 3, and containing 1 to 50 carbon atoms when y is 1 and 1 to 18 carbon atoms when y is 2 or 3; provided that when n is zero, y is 1.

The emulsifier can be a phospholipids (ix). The phospholipids of the present invention may be any lipid containing a phosphoric acid, such as lecithin or cephalin, preferably lecithin or derivatives thereof. Examples of phospholipids include phosphatidylcholine, phosphatidylserine, phosphatidylinositol, phosphatidylethanolamine, phosphotidic acid and mixtures thereof. Preferably, the phospholipids are glycerophospholipids, more preferably, glycerol derivatives of the above list of phospholipids. Typically, the glycerophospholipids have one or two acyl, alkyl or alkenyl groups on a glycerol residue. The alkyl or alkenyl groups generally contain from about 8 to about 30 carbon atoms, preferably 8 to about 25, more preferably 12 to about 24. Example of these groups include octyl, dodecyl, hexadecyl, octadecyl, docosanyl, octenyl, dodecenyl, hexadecenyl and octadecenyl.

The acyl groups on the glycerophospholipids are generally derived from fatty acids. Fatty acids are acids having from about 8 to about 30 carbon atoms, preferably about 12 to about 24, more preferably about 12 to about 18.

Examples of fatty acids include myristic, palmitic, stearic, oleic, linoleic, linolenic, arachidic, arachidonic acids, or mixtures thereof, preferably stearic, oleic, linoleic, and linolenic acids or mixtures thereof.

In the present invention, derivatives of phospholipids may also be used. Derivatives of phospholipids may be acylated or hydroxylated phospholipids. For instance, lecithin as well as acylated and hydroxylated lecithins may be used in the present invention. Acylated lecithins may be prepared by reacting an acylating agent with a lecithin.

The emulsifier may also be
R—NH2 (x)
where R =a poly(isobutenyl) group in a molecular weight of 350 to 3000. In a preferred embodiment, the poly(isobutenyl) group has a Mn=1000.

Optionally, an alcohol may be employed in the emulsified material. Typical alcohols include but are not limited to polyol-, ethylene glycol, propylene glycol, methanol, ethanol, glycerols and mixtures thereof

The alcohol may be present in the range of about 0% to about 30% preferably about 0.1% to about 20%, more preferably about 1% to about 15%, most preferably about 2% to about 10% by weight of the emulsified material.

Optionally, a propellant may be employed in the emulsified material. The propellant includes but is not limited to compressed gas, liquefied gas and mixtures thereof. The propellant gas may be used alone or in combinations thereof. The compressed gas includes but is not limited to nitrogen, nitrous oxide, air, carbon dioxide and the like. The liquefied gas includes but is not limited to butane, propane, heptanes, ethane and the like.

The propellant may be present in the range of about 0% to about 30%, preferably about 1% to about 25% and more preferably about 2% to about 20% by weight of the emulsified material.

The emulsified material is made by a batch, semi-batch or a continuous process. The process is capable of monitoring and adjusting the flow rates of the non-aqueous components, the aqueous components, emulsifier(s) and/or other additives to form a stable emulsion with the desired aqueous phase droplet size.

The emulsified material may be prepared by the steps of mixing the non-aqueous component, the emulsifier, and other non-aqueous additives using shear techniques to form the additive mixture. Then the additive mixture is mixed with water and optionally any desired water soluble additives to form the desired emulsified material.

The temperature in the range of about ambient temperature to about 200° C., and in another embodiment in the range of about 4° C. to about 150° C., and in another embodiment in the range of about 15° C. to about 90° C. and at a pressure in the range of about atmospheric pressure to about 20,000 psi, in another embodiment in the range of about atmospheric pressure to about 5000 psi and in another embodiment in the range of atmospheric pressure to about 1000 psi and in another embodiment in the range of atmospheric pressure to about 100 psi.

Alternatively, a concentrate is formed and all or substantially all the water, and water soluble additive and a portion of the non-aqueous component and all or substantially all the emulsifiers and non-aqueous soluble additives are emulsified under shear conditions to form a concentrate. The emulsified material, when used, is then blended under normal mixing conditions with the remaining portion of the aqueous phase.

The emulsification provides for the desired particle size and a uniform dispersion of the emulsified material and occurs at a shear rate in an embodiment greater than 0 s- to about 500,000,000 s-1, in another embodiment greater than 0 s- to about 100,000,000 s-1, in one embodiment about 500,000 s-1 to about 500,000,000 s-1, in another embodiment about 100,000 s-1 to about 10,000,000 s-1, in another embodiment greater than 0 s-1 to about 500,000 s-1, in another embodiment about 75,000 s- to about 1,000,000 s-, in another embodiment about 20,000 s-1 to about 200,000 s-1, and in another embodiment of about 25,000 s-1 to about 125,000 s-1 of shearing. If more than one emulsification step is used, the shear rates of the emulsification steps can be the same, similar or different. The emulsification provides for the desired particle size and a uniform dispersion of water in the non aqueous phase.

The emulsification occurs by any shear method used in the industry including but not limited to mixing, mechanical mixer agitation, static mixers, centrifugal pumps, positive displacement pumps, orifice plates, and the like. Examples of the devices include but are not limited to an Aquashear, pipeline static mixers, rotor/stator mixers and the like. The Aquashear is a low-pressure hydraulic shear device. The Aquashear mixers are available from Flow Process Technologies, Inc.

The emulsification provides for the desired particles size and a uniform dispersion.

### Specific Embodiment

The following examples demonstrate the invention.

The performance of an emulsified surface coating of the formula A

Non-aqueous phase:

Li-based grease: 12%

Sorbitan monooleate: 1%

Poly(isobutenyl)succinic acid: 3%

Calcium alkyl sulfonate: 4%

Aqueous phase:

Water: 75%

Glycerol: 5%

identified herein as ECI has been tested for surface protection and removability.

ASTM B117-97, Standard Practice for Operating Salt Spray (Fog) Apparatus is used. Emulsified cosmolene was tested in conjunction with ECI on carbon steel panels, respectively. Results indicate ECI's performance is similar to cosmolene after 356 hours of testing. The top portion of the unpainted panels were wiped free of product to display appearance of surface. Both products supply superior surface protection, there were no physical signs of degradation or disruption in the surface integrity. Testing was also conducted comparing untreated panels of carbon steel and aluminum over a period of 200 hours. Surfaces were wiped free of the surface coating to display surface protection. ECI showed superior performance to the untreated metal surfaces. The untreated metal surfaces showed signs of pithing, corrosion and degradation. The metal surface panels treated with ECI left the surfaces in tact. The ECI samples provided equivalent protection to Cosmolene and Wrap Guard samples on metal surfaces or coated metal surfaces during transport.

ASTM D4049, Standard Test Method for Determining the Resistance of Lubricating Grease to Water Spray, allows for the determination of the removability of the product. The ECI material is applied at about 0.8 mm film thickness to carbon steel panels. The panels are allowed to dry or cure at about 60 degrees Celsius for about 18 hours. The panels are then exposed to a water spray at about 40 psi and about 38 degrees Celsius. Results indicate ECI is about 99% removed from the carbon steel panels. The remaining 1% is readily removed by a detergent spray wash. The cosmolene was tested in a similar fashion. Results indicate the cosmolene was removed at about 55%. The remaining material required solvent washes and detergent spray wash for complete removal of the cosmolene.

Field tests using cars were conducted. An untreated carbon steel panel, coated with two coats of the product, cosmolene and an ECI coated panel were attached to the bumper of cars. The cars were allowed to travel 362 miles during winter de-icer on roadways in and around Cleveland, Ohio. ECI performed as well as the cosmolene product sample

Field testing was also conducted on line haul trucks during their normal travels in Wisconsin, where magnesium chloride de-icers are used on roadways. After 25,000 miles, the ECI coated panels do not display any signs that the surface integrity has been compromised.

From the above description and examples of the invention those skilled in the art will perceive improvements, changes and modifications in the invention. Such improvements, changes and modifications within the skill of the art are intended to be covered by the appended claims.

We claim:

1. A method for coating a surface of a substrate comprising the steps of: (a) applying an aqueous discontinuous emulsified material to a surface of a substrate and (b) drying or allowing to dry the emulsified material as a surface coating on the substrate.

2. The method of claim 1 comprising the further step of (c) removing the surface coating from the substrate.

3. The method of claim 1 wherein the emulsified material comprises (a) a major amount of an aqueous phase, (b) a minor amount of a non-aqueous phase and (c) a minor but effective amount of at least one emulsifier to emulsify the aqueous and non-aqueous phase resulting in an emulsified material.

4. The method of claim 3 wherein the emulsified material comprises at least one component selected from the group consisting of water soluble additive(s), alcohol(s), organic soluble additive(s), propellant(s), thickener(s), corrosion inhibitor(s) or mixtures thereof.

5. The method of claim 1 wherein the emulsified material has an aqueous phase content in the range of about 5% to about 99% by weight of the emulsified material.

6. The method of claim 1 wherein the emulsified material has an aqueous phase content in the range of about 60% to about 85% by weight of the emulsified material.

7. The method of claim 1 wherein the emulsified material has a viscosity in the range of about 200 cSt to about 5,000,000 cSt.

8. The method of claim 3 wherein the emulsified material has a non-aqueous phase selected from the group consisting of organic materials, oils, greases, thickened oils, thickened grease, gels, thickened solvents, monomers, polymeric materials, solvents, waxes and mixtures thereof and in the range of about 1% to about 95% by weight of the emulsified material.

9. The method of claim 1 wherein the surface coating is applied as a thin film coating to a substrate and acts as a barrier, a strengthener for the surface, corrosion protection, evaporation protection, oxidation protection, water protection, adhesion protection, dissociation protection, degradation protection, wear protection or mixtures thereof

10. The method of claim 1 wherein the surface coating is selected from the group consisting of a translucent coating, opaque coating, transparent coating, permanent coating, semi permanent coating, temporary coating, removable coating and combinations thereof

11. The method of claim 1 wherein the substrate for the surface coating to be coated is selected from the group consisting of metal, wood, concrete, stone, asphalt, glass, plastic, composites, fabric, rubber, carbon steel, stainless steel, aluminum and mixtures thereof.

12. The method of claim 1 wherein the surface coating is applied by a method selected from the group consisting of spraying, dipping, spinning, vacuum depositing, reverse rolling, wire-wounding, direct and offset gravure, slot dieing, blading, hot melting, curtaining, knife over rolling, extruding, air knifing, rotary screening, multilayer sliding, painting, brushing, co extrusioning, meniscusing, micro gravure coating, atomizers and combinations thereof.

13. The method of claim 1 wherein the surface coating is applied by a method selected from the group consisting of spraying, painting, rolling, brushing and combinations thereof.

14. The method of claim 1 wherein the surface coating is applied by a method selected from the group consisting of an aerosol container and an application of airless atomization; fluid delivering air space system that is pressurized or suction fed; a pressure-feed system with air-assisted airless internal mixing atomization; a compressed air operating at about 35 to about 1050 kPa with the range of about 5 to about 150 psi adjacent to the airless nozzle and impinges upon the thin sheet of fluid as it exits from the spray nozzle orifice in the range of about 0.0005″ to about 0.020″ tips; and combinations thereof.

15. The method of claim 1 wherein the coating is dried by a method selected from the group consisting of evaporation, dissipation, curing, heating and combinations thereof.

16. The method of claim 1 wherein the dried surface coating has a thickness in the range of about 0.01 micron to about 50 microns.

17. The method of claim 3 wherein the emulsified material further comprises thickeners, non-aqueous thickeners, viscosity modifiers, water soluble additives, extreme pressure additives, antiwear additives, metal deactivators, dispersants, antifoams, water soluble organic compounds, biocides, alcohols, corrosion inhibitors, rust inhibitors, antioxidants, detergents, polymers, functionalized polymers, organic soluble additives, alcohols, propellants, an anticorrosion modifier in the non aqueous phase or mixtures thereof.

18. The method of claim 4 wherein the propellant(s) is selected from the group consisting of maybe liquefied, compressed gas and mixtures thereof

19. The method of claim 1 wherein the emulsified material comprises a water emulsified into a non aqueous phase and wherein the non aqueous phase comprises grease and an anticorrosion modifier.

20. The method of claim 3 wherein the emulsifier is present in the range of about 0.1 to about 20% of the emulsified material and comprises,
(i) a oil soluble product made by reacting at least one hydrocarbyl-substituted carboxylic acid acylating agent with ammonia or an amine including but not limited to alkanol amine, hydroxy amine, and the like, the hydrocarbyl substituent of said acylating agent having about 50 to about 500 carbon atoms;
(ii) any other acylating agent having at least one hydrocarbyl substituent of up to about 40 carbon atoms, and reacting that said acylating agent with ammonia or an amine;
(iii) any other ionic or a nonionic compound having a hydrophilic-lipophilic balance (HLB) of about 1 to about 40;
(iv) the reaction product of polyacidic polymer with at least one oil soluble product made by reacting at least one hydrocarbyl-substituted carboxylic acid acylating agent with ammonia, an amine, a polyamine, an alkanol amine or hydroxy amines;
(v) an amino alkylphenol which is made by reacting an alkylphenol, an aldehyde and an amine resulting in an amino alkylphenol;
(vi) a hydrocarbyl substituted carboxylic acid, or a reaction product of the hydrocarbyl substituted carboxylic acid or a reactive equivalent of such acid with an alcohol, the hydrocarbyl substituent of the acid or reactive equivalent thereof containing at least about 30 carbon atoms;
(vii) at least one compound represented by one or more of the formulae: 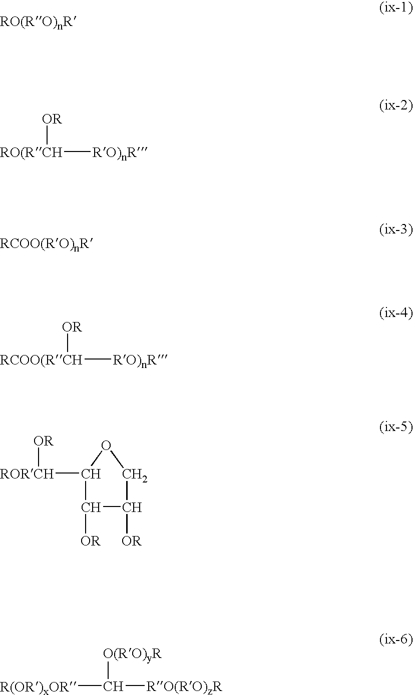
wherein each R is independently hydrogen or a hydrocarbyl group of up to about 60 carbon atoms; each R′ and R″ is independently an alkylene group of 1 to about 20 carbon atoms; each R′″ is independently hydrogen, or an acyl or hydrocarbyl group of up to about 30 carbon atoms; n is a number in the range of zero to about 50; and x, y and z are independently numbers in the range of zero to about 50 with the total for x, y and z being at least 1;
(viii) an etheramine used to the make the emulsified material can be represented by the formula
R²O[CH₂CH(R)O]ₙ—R¹—NH₂
wherein each n is a number from 0 to 50; each R is selected from the group consisting of hydrogen, hydrocarbyl groups of 1 to 16 carbon atoms, and mixtures thereof; each R.sup.1 is selected from the group consisting of a hydrocarbylene group containing 2 to 18 carbon atoms and a group represented by the formula
—R⁶Nₚ—R⁷—
wherein both R⁶ and R⁷ are hydrocarbylene groups of 3 to 10 carbon atoms and p is a number from 1 to 4; and each R² is a hydrocarbyl group having a valence of y where y is a number from 1 to 3, and containing 1 to 50 carbon atoms when y is 1 and 1 to 18 carbon atoms when y is 2 or 3; provided that when n is zero, y is 1;
(ix) a phospholipid, any lipid containing a phosphoric acid, such as lecithin or cephalin;
(x) An amine represented by the formula:
R—NH₂
where R=a poly(isobutenyl) group of molecular weight between 350 and 3000; or
(xii) the combination of any other above listed emulsifiers.
